(19) United States
(12) Patent Application Publication
(10) Pub. No.: US 2008/0062183 A1
(43) Pub. Date: Mar. 13, 2008

(54) Hybrid data structures for graphics programs

(76) Inventor: Bart Swaelens, Putte (BE)

Correspondence Address: BACON & THOMAS, PLLC, 625 SLATERS LANE, FOURTH FLOOR, ALEXANDRIA, VA, 22314, US

(21) Appl. No.: 11/898,095

(22) Filed: Sep. 10, 2007

Related U.S. Application Data
(60) Provisional application No. 60/843,410, filed on Sep. 11, 2006.

(51) Int. Cl. G06T 15/00

(52) U.S. Cl. 345/522; 345/536

(57) ABSTRACT

The use of data structures for displaying images is described: A first minimal data structure. In this structure only that information needed to show the data in the form of a 3D image, either wire mesh or rendered, to the user, is loaded into memory, e.g. the RAM memory. No additional information about the data structure is generated. For example, no connectivity data is loaded into memory. Typically this memory state is used for “read-only” purposes. In other words, the data objects are not to be modified. A second Rich (Flexible) data structure. In this structure, information, which a typical application holds to perform operations on the data, will be kept in memory, e.g. a RAM memory. Optional examples of extra information needed are, connectivity data such as neighbor information, some data flags for polygons, e.g. triangles and vertices, references to next and previous vertices and polygons, e.g. triangles, etc. In order to perform complex operations on big datasets in a somewhat efficient way, such extra information is preferred. A third data structure mainly in the non-volatile memory. In this structure the bulk of the data will be put into the non-volatile storage again, but in such a way that it can very easily be converted into one of the other memory structures again that are mentioned above. The structure in RAM will be similar as in 1 or 2, but will contain a reduced version of the data: for instance the 3D model will be described with less polygons, ultimately with only 6 polygons (the bounding box).

The present invention relates to computer graphics programs for visualizing and processing 3D polygonal data structures as well as to the data structures themselves and to images generated from the data structures images, e.g. those whose surfaces are represented by polygonal meshes as well as to data structures for se therewith.

### TECHNICAL BACKGROUND

Three Dimensional Software graphics programs that work with polygonal data such as triangle data as shown in FIG. 1 are confronted with a dilemma in creating their internal data-structure. Either a data structure is used that is very compact, which minimizes the use of computer memory, but which is typically not flexible enough to make changes to the 3D geometry of the 3D model. Another solution is a much more flexible data-structure, but this consumes much more memory.

Applications working with large amounts of data sometimes suffer from loss of performance because the available physical memory (Random Access Memory or RAM) is not sufficient for holding all the necessary data. The Operating System (OS) will then typically swap certain parts of the computer memory to disk, e.g. into a swap file. The OS will read the data back from disk if the program makes use of this memory. This process can be time consuming.

Typical examples are the applications working with 3D models represented by polygonal meshes such as triangle meshes. The triangle meshes have to be loaded into memory in order to be manipulated inside the application. If there are modifications these are saved again on disk in a modified way.

If a flexible data structure is used, the amount of RAM memory needed to hold such a dataset from file in memory is not the same as the disk-space required for the dataset. It can even be multiple times bigger than the disk space required to store the same data. For example, triangle mesh data is typically stored on hard-disk as STL files. These are files describing a collection of triangles. For STL files, a triangle on disk is written by or stored as 3 times 3 coordinates, i.e. 3 coordinates for each of the 3 vertices of a triangle. This means that at least 9*4 (4 bytes=1 floating point number)=36 bytes are required to describe one triangle on disk. In the STL file format this is 50 bytes, because there is also information about the normal on the triangle stored. In practical applications, the amount of triangles in such a triangle files is constantly increasing, going to several millions of triangles, which generates files of 500 Mbytes and more.

A minimal way to store these triangles into memory is to have an array of points and an array of triangles. The array of points will contain all the points, listed in a certain order. Since there are 3 coordinates (x, y, z) for each point and 1 coordinate needs 4 bytes, there are 12 bytes needed per point. Because the number of points in a typical (closed) triangle mesh is half the number of triangles, 6 bytes per triangle are needed.

The triangles are then also stored in an array, where for each triangle, the reference to the 3 points (3×4 bytes) is stored plus a description of the normal on the triangle (another 4 bytes), which consumes in total 16 bytes per triangle. So in total this type of memory structure would need only 22 bytes per triangle.

However, if the application is performing certain CAD operations on the triangle meshes (e.g. Boolean operations) certain triangles will have to be cut into multiple triangles and/or certain triangles must be deleted and/or triangles and points have to be added to the structure. For those types of changes, such a double array structure is not very suitable, because it will be slow to add and delete triangles and points, and the memory will get fragmented.

To work more efficiently a rich data structure can be created. In this case it is needed to have some information about the neighbor triangle(s) in each of the vertices and triangles and references in each of the triangles to the next and previous triangles in order to be able to remove the triangle(s) in an efficient way. Such information is called “connectivity data”.

Then the list of points will contain
references to the triangles that are connected to the points (on average 6 triangles, thus consuming 24 bytes)
references to the next and previous points (8 bytes)
X,Y,Z information for each point: 12 bytes
And possibly some extra info (e.g. 12 bytes)
   Thus in total 48 bytes are required.

Since the number of points it typically half the number of triangles, in total 24 bytes per triangle are needed for storing the list of points.

The list of triangles contains:
references to the 3 points (12 bytes)
full information about the normal on the triangle (direction of the triangle): 3×4 bytes
references to the next and previous triangles (8 bytes)
And possibly some extra info (e.g. 12 bytes)
   Thus in total 44 bytes per triangle are required for the list.

In total 72 bytes per triangle are needed to store a triangle mesh in such a rich structure. If there is a lot of extra information also stored, this can go up to 100 bytes.

Thus, although the calculations will go much faster with such a rich data structure, it will need 4 times more memory, which restricts the number of files that can be loaded at a time.

In case a user wants to load 100 files of on average 1 million triangles, the rich data structure will consume 8200 million bytes, which is physically impossible with today's PC hardware. With a minimal data structure, it would consume only 2200 million bytes, which is much more feasible with today's PC hardware and operating systems.

### SUMMARY OF THE INVENTION

It is an object of the present invention to improve speed at which large data files such as 3D polygonal, e.g. triangle graphics files can be loaded and/or processed and/or viewed in a computer system.

An aspect of the present invention is to provide and use a hybrid data structure, that can be both compact and flexible.

The present invention also provides a computer system comprising: a memory system (e.g. a random access memory, a non-volatile memory), a processor, one computer program running on the processor, a display device, a first data structure being a first representation of a 3D polygonal Model and residing in the memory system such as the volatile memory or non-volatile memory and occupying a first amount of memory space and a means for converting the first data structure into a second data structure residing in the memory system such as the volatile memory and occupying a second amount of memory space being a second representation of the 3D polygonal Model.

The first and second 3D surface representation of the model may represent the model with the same image resolution. Either of the first or second data structure may be polygonal mesh representations of the surface of the 3D model with or without connectivity data. The first or second data structure may be displayed on the display device, e.g. as a wire frame or as a rendered image. In the latter case the computer program may include a rendering program. Optionally, further data structures may be provided, each structure, for example, being a 3D surface representation of the model and each of these may optionally represent the model with the same image resolution. In particular, the data structures may be:
1. A first minimal data structure. In this structure only that information needed to show the data in the form of a 3D image, either wire mesh or rendered, to the user, is loaded into memory, e.g. the RAM memory. No additional information about the data structure is generated. For example, no connectivity data is loaded into memory. Typically this memory state is used for “read-only” purposes. In other words, the data objects are not to be modified.
2. A second Rich (Flexible) data structure. In this structure, information, which a typical application holds to perform operations on the data, will be kept in memory, e.g. a RAM memory. Optional examples of extra information needed are, connectivity data such as neighbor information, some data flags for polygons, e.g. triangles and vertices, references to next and previous vertices and polygons, e.g. triangles, etc. In order to perform complex operations on big datasets in a somewhat efficient way, such extra information is preferred.
3. A third data structure mainly in the non-volatile memory. In this structure the bulk of the data will be put into the non-volatile storage again, but in such a way that it can very easily be converted into one of the other memory structures again that are mentioned above. The structure in RAM will be similar as in 1 or 2, but will contain a reduced version of the data: for instance the 3D model will be described with less polygons, ultimately with only 6 polygons (the bounding box).

The first data structure may be stored in random access memory as a simple array. The second data structure may be stored in random access memory as a linked list. The first data structure may be quicker to store in random access memory than the second data structure. The first data structure may be slower to manipulate for additions and deletions than the second data structure.

The computer program may be adapted to load data in the first to third data structures based on:
a) a user graphics operation, e.g. opening a file, attempting to perform a manipulation on the,
b) automatically at certain times or after certain operations,
c) based on a user entered request.

### BRIEF DESCRIPTION OF THE DRAWINGS

FIG. 1 shows an image of a 3D model in the form of polygons with which the present invention can be used.

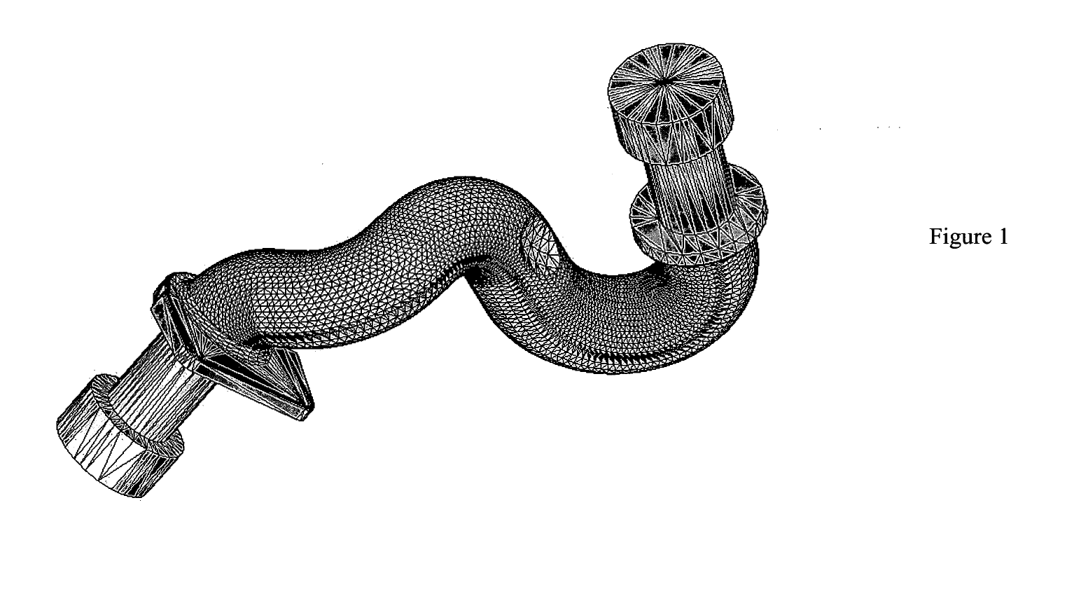

FIG. 2 shows a schematic view of a computing system according to an embodiment of the present invention.

FIG. 3 shows a flow diagram according to an embodiment of the present invention.

FIGS. 4a and b show representations of data structures in memory for use with the present invention.

FIG. 5 shows a representation of other data structures in memory for use with the present invention.

### DESCRIPTION OF THE ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

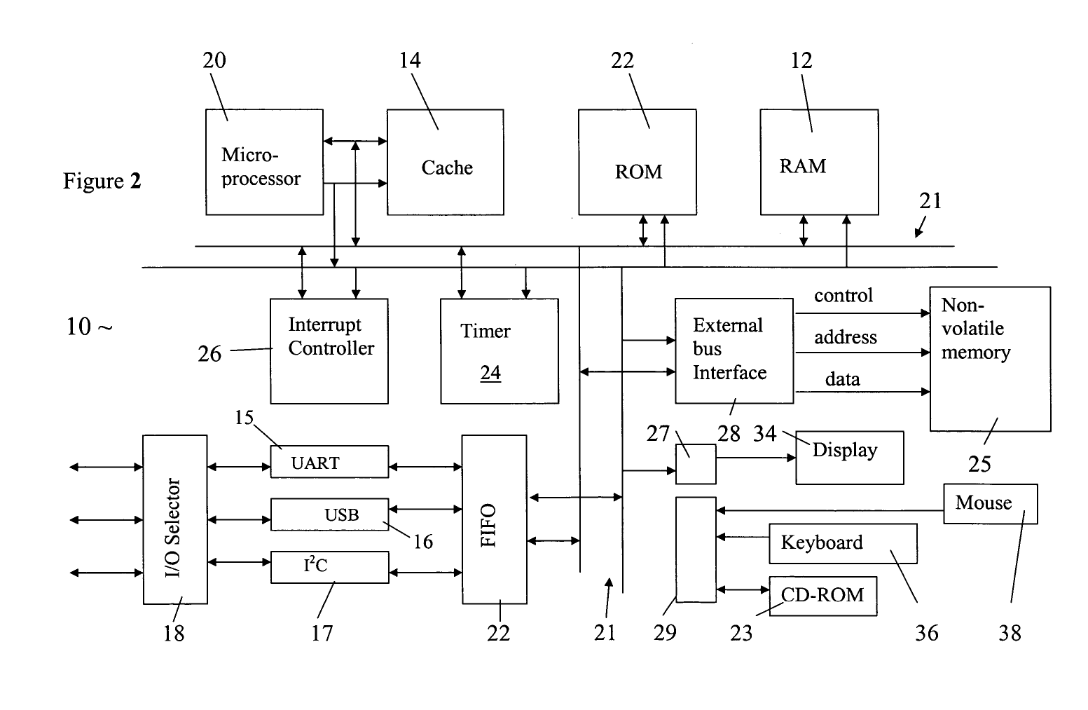

An example of a computing environment for use with the present invention is shown in FIG. 2 schematically. The elements shown in FIG. 2 may be functional blocks which are not necessarily to be found in discrete hardware components but rather distributed as required. A computing device 10 may be a computer such as a personal computer or workstation. The computing device 10 includes a central processing unit (“CPU”) or microprocessor 20 such as a Pentium processor supplied by Intel Corp. USA or similar. A RAM memory 12 is provided as well as an optional cache memory 14 or co-processor. Various I/O (input/output) interfaces 15, 16, 17 may be provided, e.g. UART, USB, I²C bus interface as well as an I/O selector 18 for receiving data from a suitable source, e.g. from a modem, for connecting to network, etc. The USB interface for example can be used to attach solid state memory devices, e.g. non-volatile solid state memory devices, hard drives, etc. FIFO buffers 22 may be used to decouple the processor 20 from data transfer through these interfaces. A counter/timer block 24 may be provided as well as an interrupt controller 26. The various blocks of computing device 10 are linked by suitable busses 21.

Various interface adapters 27-29 can be provided. Adapter 27 is an interface adapter, e.g. a display adapter, for connecting system bus 21 to an optional video display terminal 34. Further adapters 29 provide an input/output (I/O) adapter for connecting peripheral devices (e.g. an optical drive such as a DVD or CD-ROM drive 23) to system bus 21. Video display terminal 34 can be the visual output of computer device 10, which can be any suitable display device such as a CRT-based video display well-known in the art of computer hardware. However, with a portable or notebook-based computer, video display terminal 34 can be replaced with a LCD-based or a gas plasma-based flat-panel display. Computer device 10 further includes connecting a keyboard 36, mouse 38, and optional speaker, etc. using adapter 29. Access to an external non-volatile memory 25 such a hard disk may be provided an external bus interface 28 with address, data and control busses.

Optionally, software programs may be stored in an internal ROM (read only memory) 22 and/or may be stored in the external memory 25. An operating system may be implemented as software to run on processor 20. A graphics program suitable for use by the present invention may be obtained by programming of the processor 20. The methods and procedures of the present invention may be written as computer programs in a suitable computer language such as C++ and then compiled for the specific processor 20 in the device 10.

The present invention relates to data structures to be stored on the external memory 25, e.g. hard disk, and/or internal memory such as RAM 12 and/or on or in any other form of memory such as a memory device attached to a USB port or inserted in PCMCIA slot of the computing system, a magnetic tape memory device or an optical memory disk such as a CD-ROM or DVD-ROM readable and writable disk and to data that is to be transferred between these two memories under control of processor 20.

To overcome the dilemma of the prior art, the present invention proposes in a first embodiment an intelligent hybrid data structure. The present invention proposes allowing different data structures (representing objects to be viewed and manipulated) to be available to a graphics application program. At least two different data structures (representing objects to be viewed) are provided by embodiments of the present invention. In other embodiments three different data structures are provided.

Depending on which operations a user wants to perform on the objects, the application will convert the object(s), stored in or on a non-volatile memory such as a hard disk or a USB solid state memory device, a magnetic tape memory, an optical memory disk, etc., into a memory state which is most suited for a particular kind of operation. The latter memory state may be stored in any suitable volatile memory such as random access memory (RAM) or in any suitable non-volatile memory. The data structures proposed can all represent 3D polygonal models having the same resolution. Accordingly, embodiments of the present invention provide constant-resolution swapping from a first data structure representing a 3D polygonal surface structure of a model with a first resolution to a second data structure representing a polygonal representation of the 3D model with the same first resolution, e.g. to swap from one data structure having connectivity data between polygonals of a surface representation to another data structure without connectivity and having the same resolution or vice versa.

There are generally two types of data structures used in computing systems, e.g. used in digital computers having a memory and a processor such as a microprocessor. These data structures are arrays and linked lists. A list is a sequence of vertices where associated with each vertex is a data item and a next vertex. The association with the next vertex can be as simple as making the next data item contiguous in memory with the first data item. For example, lists may be used in an array implementation in which data items are stored in sequential memory locations in an array. Generally, it is only possible to insert or delete data easily at the ends of such an array. If the array is stored in a stack, only one end of the stack may be used to push or pop a data item (last in-first out). In a queue, data items are added at one end and removed from another (first in-first out).

Arrays are simple data structures that are quick to store and retrieve. It is more difficult to insert or delete data from the middle of the array. To do this it is necessary to slide all the data in one direction or another so as to close up a hole after a deletion or to create a hole for an addition. This sliding process takes up processor time. To make insertion or addition in the middle easier, pointers can be used. A pointer is a variable whose value denotes an address in memory. Each element in the list can be represented by a vertex that contains the data and a pointer to the next data element and/or the previous data element. Addition and deletion then only requires modifying the relevant pointers to insert or delete a data item. Such a list is sometimes called a linked list. Linked lists can be doubly or singly linked. If singly linked there is only a pointer associated with each item that points to the next data item. In doubly linked lists there are pointers to the previous data item and the next data item.

Linked lists increase the amount of memory required to store the data and hence increase the time to transfer a large array of data items to memory but any subsequent manipulation of the data, e.g. involving insertion or addition, is much quicker.

A linked list can contain a list header that can store global information about the list such as list size and pointers to the first and/or last vertices and/or information relevant to the application, e.g. the name of an object used by a computer program. If headers are not used the same information can be stored in additional variables.

Linked lists can make use of pointer variables. A variable can be declared that contains the address in memory of a data item and an operator can be provided to go between the pointer and the data that is pointed to. Another method of implementing pointers is using an array field. In this case the linked list is stored as a simple array. Each entry in the memory includes:
1) a first part that indicates if the entry is free or not,
2) a second part that is the data item itself,
3) a third part that is a first pointer to the address of the next data item, and optionally
4) a fourth part that is a second pointer to the address of the previous data item.

The present invention includes within its scope any way of storing a simple array or similar or of storing a linked list or similar. A useful source of information about data structures and memory can be found in “An introduction to data structures and algorithms”, J. A. Storer, Birkhäuser Springer 2002.

In the following it will be explained how arrays and linked lists can be used to provide the advantage of the present invention.

If, e.g., a user simply wants to visualize a polygonal mesh, e.g. triangle mesh, a lot of the extra references, which the application normally constructs, are not needed in RAM. Hence a first data structure may be compact and not have connectivity data, for instance. Accordingly, the data structure that can be selected is a simple array. Only when the user performs an operation which requires extra references, e.g. connectivity data, these references will be created in memory, e.g. non-volatile memory such as RAM by converting the first data structure to a completely different second data structure. It is not enough to create some extra information at some point in time, the basic data structure itself is completely differently organized. For example, the data is now stored as a linked list.

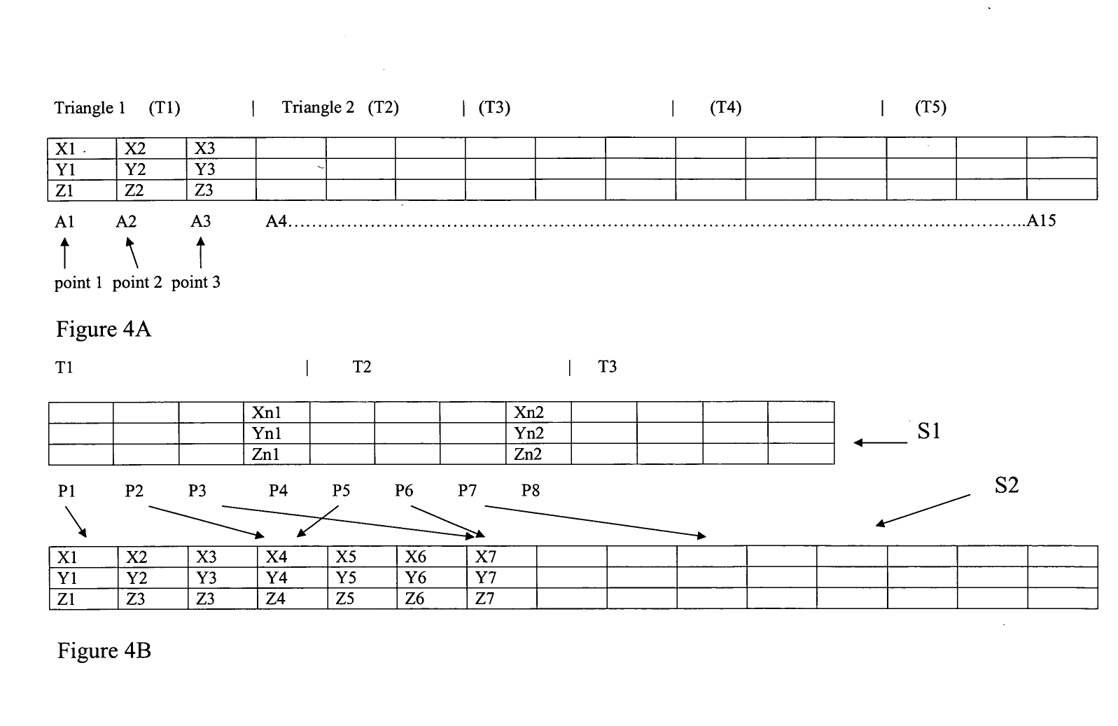

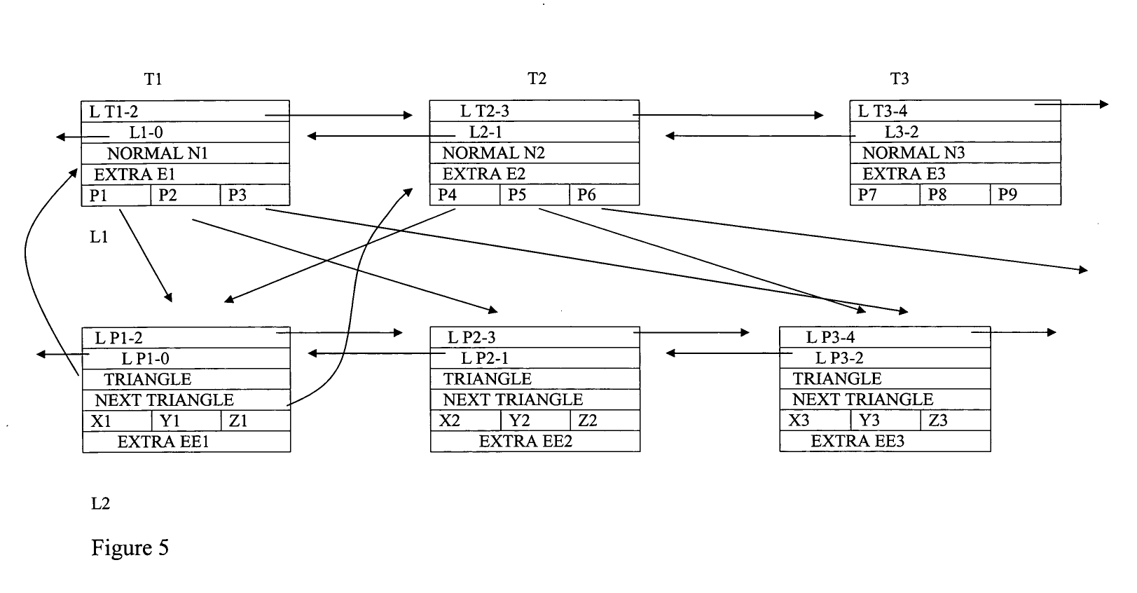

Examples of the use of arrays and linked list will be described with reference to FIGS. 4 and 5.

In FIG. 4a a simple array data structure is shown in the form of a minimal data structure. An important characteristic of this data structure is that it is quick to load into memory, e.g. random access memory. Also it is difficult to modify the data structure by addition or deletion. This means that the data structure is such that it results in slower execution of manipulations on the data as required for some graphics operations, e.g. making a section through an object. The array is shown as a horizontal sequence of addresses or sub-addresses A1 to A15, etc. in memory but the horizontal representation is not a limiting feature of the present invention.

The data structure is stored in contiguous memory, each address or sub-address A1 to 15, etc. storing coordinate data of a vertex of a triangle (X1, Y1, Z1, etc). Hence there are three entries for each triangle T1 to T5, etc. (A1, A2, A3; etc.). The link to the next triangle in the sequence is provided by the position in memory, i.e. the next one in contiguous memory. For simple manipulations such as translation or rotation, an operation can be performed on each address or sub-address to change each value and write it back at the same position in memory. No connectivity or extra data is shown as being stored in this data structure.

FIG. 4b shows another minimal data structure that can be used with the present invention. In a first section of contiguous memory S1, there are four entries defined by memory addresses or sub-addresses P1 to P8, etc. for each triangle T1, T2, etc. Three of the entries are pointers (P1, P2, P3; P5, P6, P7) to the data for individual points of the triangle (X1, Y1, Z1, etc.). The fourth entry (P4, P8, etc.) is the co-ordinates of a vector defining the normal to the triangle. The vector defining the normal to the triangle is a useful data element in manipulating graphics files.

Each pointer P1 to P3; P5 to P7 etc. points to part of another section of contiguous memory S2 where the data for each point is stored X1, Y1, Z1, etc.). The points are stored in groups of three addresses or sub-addresses as required for triangles. As can be seen from the section S2 some pointers such as P2 and P5 point to the same point data (X4, Y4, Z4). This refers to a common point between the two triangles T2 and T1. This saves one data entry for each such point in the memory.

In both of the data structures of FIGS. 4a and b, the physical order of the data points in contiguous memory define the relationships between the triangles. If a triangle has to be deleted or added, it is necessary to recreate the data structure at least in one direction from the deletion or addition. This means that the data structures are slower to manipulate where such additions or deletions are necessary but are quick to load into memory, such as random access memory.

FIG. 5 shows an alternative data structure for use with the present invention. It comprises two linked lists L1 and L2. In linked list L1 basic information is stored concerning each triangle T1 to T3, etc. For each group of entries in memory there is stored a link L T1-2, L T2-3, LLL T3-4, etc. to the next triangle and a link L T1-0, L T2-1, L T3-2, etc. to the previous triangle. The normal for each triangle (N1, N2, N3) is also stored. Optionally, extra information (E1, E2, E3) can also be stored, e.g. the color of the triangle, a flag to indicate if the triangle is hidden or not, etc. . . . Also there are pointers (P1, P2, P3; P4, P5, P6; etc.) to the coordinate data for each vertex of the triangle (X1, Y1, Z1; X2, Y2, Z2; etc.). This point data is stored in other part of memory as a linked list L2. The entries for each point include pointers to the next (L P1-2, L P2-3, L P3-4) and previous points (L P1-0, L P2-1, L P3-2), a link to the present (TRIANGLE) and next triangle (NEXT TRIANGLE) and the relevant data for that point (X1, Y1, Z1; X2, Y2, Z2; etc.). Optionally, extra information (EE1, EE2, etc.) can also be stored, e.g. a flag to indicate that the point itself should be visualized, the color of that point, a reference to a line between the points, etc. . . .

With the data structures of FIG. 5, it takes longer to store them as many more entries are required but the manipulation of the data such as additions or deletions can be carried out much faster.

Although triangles have been referred to with respect to FIGS. 4 and 5, the present invention is not limited to triangles. If polygons with n sides are used, then there will be n point data rather than 3 point data stored in memory.

The present invention includes within its scope that different kinds of data structures in memory can be created. In an embodiment of the present invention 3 different structures are provided. An application such as a graphics application can select between these two or three different data structures dynamically and convert, for example the 3D polygonal surface representation of a 3D model stored in RAM (e.g. as a simple array as shown for example in FIG. 4 a or b) into another of the data structures of the present invention, that second data structure also being a polygonal surface representation of the model in RAM (e.g. as a linked list such as the data structures of FIG. 5).

Data structures which are included within the present invention are:
1. A first minimal memory structure: In this structure only that information needed to show the data in the form of a 3D image, either wire mesh or rendered, to the user, is loaded into memory, e.g. a non-volatile memory such as RAM. No additional information about the 3D model is generated. For example, no connectivity data is loaded into memory. A good example of a data structure of this type is a simple array such as shown in FIG. 4a. Typically this memory state is used for “read-only” purposes. In other words, the data objects are not to be modified. The reason for this is that a simple array is easy to load and to display and simple manipulations such as translation and rotation can be performed quickly but the data structure is difficult to modify. Certain manipulations of polygons of a 3D model to be displayed require additions and/or deletions and these are difficult with a simple array.
2. A second Rich (Flexible) memory structure: in this structure, information, which a typical application holds to perform operations on the data, will be kept in memory, e.g. a non-volatile memory such as RAM. Typical examples of extra information needed are, connectivity data such as neighbor information, some data flags for polygonals, e.g. triangles and vertices which holds whether or not they have been processed by some algorithm, references to next and previous vertices and polygonals, e.g. triangles, etc. . . . In order to perform complex operations on big datasets in a somewhat efficient way, such extra information is preferred. A good example of the data strature that may be used is a linked list as shown for example in FIG. 5.
3. A third (on disk) structure in non-volatile memory, e.g. an on-magnetic disk structure, an on-tape structure, an on optical disk structure, a solid state memory structure etc.: in this structure the bulk of the data will be put into non-volatile storage such as on hard disk, magnetic tape, optical memory disk, solid state memory, etc. again, but in such a way that preferably it can very easily be converted into one of the other memory structures again that are mentioned above. (the minimal or rich data structure) The ability to create a swap file on or in a non-volatile memory such as a disk which is effectively used as RAM is provided by some operating systems. In this type of data structure, the data object will require only a minimum of RAM. Except for some cached data, most of the data will be stored on the non-volatile memory such as on a hard disk. In the example of the polygonal, e.g. triangle meshes, the object will have to be shown in some reduced form, like e.g. a bounding box of the object. However, reloading from the non-volatile memory such as the disk can take extra time.

The present invention is not limited to two or three data structures. More different types of structures are included within the scope of the present invention. Some special type of operations can require special type of data to be generated. Data structures may be required which are used by specific graphics software programs, i.e. containing specific information used exclusively by such a program.

An aspect of the present invention is to reduce the memory usage again from the moment it is not absolutely required anymore. This means that as soon as manipulations of data are no longer necessary the data is converted to a representation requiring less data in non-volatile memory, e.g. RAM, e.g. conversion to a “read-only” type of data.

In accordance with a second embodiment of the present invention, the time taken for swapping from one data structure to another is addressed. If the application would switch between different memory structures for all operations, this would consume a lot of time, and eliminate all advantages. The present invention proposes in this embodiment a control algorithm for the swapping from one data structure to another.

For example, if there are certain operations (a,b,c,d) which would be best done with a minimal data structure, and other operations (E,F,G,H) where the Rich data structure is more suited, a sequence of operations like [a E b F c G d H] would require 7 conversions between the data structures. To overcome this problem, a number of solutions are proposed, each one of which is an embodiment of the present invention:

1. Double implementation of some operations.

Alternative implementations of operations using one data structure are provided so that the same operation is also possible in another structure. For example alternative implementations of the operations E and F are provided that can run in the minimal data structure (let us call these new operations e and f), and an alternative operation D for operation d that can run in the Rich data structure. The graphics program can use the following operations [a e b f c G D H] and get the same result as executing [a E b F c G d H]. However, the first sequence will only require 1 conversion between the data structures, and will therefore be much more efficient and faster.

In a preferred embodiment all the operations can be implemented in the Rich data structure, and only some limited operations in the minimal data structure.

2. Intelligent prediction about which operations the user will perform.

Because users are typically performing the same operations, but with other data, a prediction algorithm can be used to optimize the operations performed by a user. The software program can predict which operations the user will perform based on an algorithm, e.g. based on historical information about the user's actions on any data or, for example, about how the particular data has been used by any user in the past. Such an algorithm can be built into the software, or the software can include a learn function so that the program learns from the individual user or users.

If the software knows that the user will perform a series of operations that are all optimal in a certain data structure, the software can first (before the first of the series) convert the data into the appropriate data structure, and next start performing the operations. In accordance with an aspect of the present invention the software detects the start of such a series of operations and changes the data structure, e.g. after first informing the user and asking whether such a conversion is desired or appropriate and optionally requesting an action is carried out, e.g. press a key, or first informing the user that the conversion will take place, e.g. within so many seconds unless an action is carried out, e.g. press a key, or the conversion is done automatically.

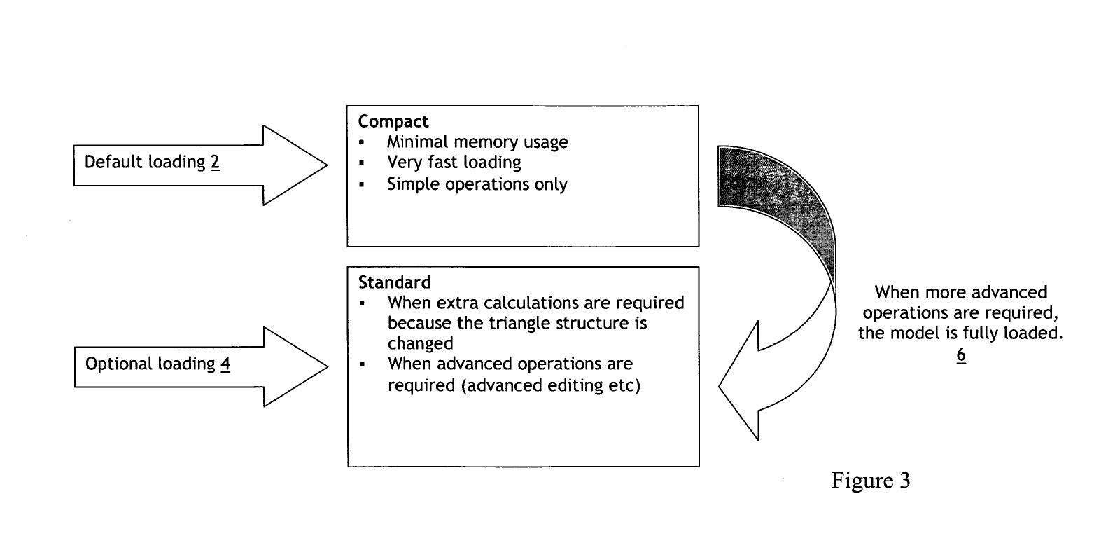

A typical example of this is described in the following with reference to FIG. 3: When a user loads triangle data in a software program, the user first wants to see and inspect the object. For all those operations, the minimal data structure is optimal, and therefore the software will a) first inform the user and ask whether the minimal representation is desired or appropriate and optionally request an action is carried out, e.g. press a key, or b) first inform the user that the minimal representation will be loaded, e.g. within so many seconds unless an action is carried out, e.g. press a key, or c) will automatically load (in step 2) the data initially into the minimal data structure. When the first operation is initiated by the user, that is more suited for the Rich data structure, the software will a) first inform the user and ask whether the conversion is desired or appropriate and optionally request an action is carried out, e.g. press a key, or b) first inform the user that the minimal representation will be loaded, e.g. within so many seconds unless an action is carried out, e.g. press a key, or c) will convert to the Rich data structure in steps 4 and 6 automatically. The program keeps all further operations in this data structure, because it is likely that the user will perform other complex operations after the first one.

When the software detects that the memory consumption is high, and that certain objects are not used for a long time, the software can automatically convert those objects back into another data structure such as minimal data structure—reverse of step 6, or the program can ask the user if this conversion may be done, e.g. a) first inform the user and ask whether the new representation is desired or appropriate and optionally request an action is carried out, e.g. press a key, or b) first inform the user that the new representation will be loaded, e.g. within so many seconds unless an action is carried out, e.g. press a key.

All these conversions can be done either at the moment when the user is requesting a certain operation, or during idle time (e.g. when the user is only looking to the object), e.g. in background, which again reduces the overhead for the user.

3. Guidance of users.

In accordance with a third embodiment of the present invention, if it does not matter in what sequence the operations are performed, the software guides the users during display and manipulation of the images. This can be done by grouping the operations into the user-interface, or by giving indications to the users, e.g. via pop-ups (e.g. ‘Do you really want to perform this operation now? Perhaps it is better that you perform this operation at the end?’).

In the example from above, in an embodiment providing grouping a Toolbar is constructed with the operations (a,b,c,d) and another toolbar with the operations (E,F,G,H). Or a wizard-like interface can be provided where first only the operations (a,b,c,d) are available, and next only the operations (E,F,G,H). Further a wizard may be provided in which the user inputs the intended operation sequence and the wizard proposes optimized variations of the sequence, whereby memory operations are reduced.

The present invention provides at least one of the following advantages:
1. Using the present invention offers multiple advantages to a user of such “big data” applications.
2. A big advantage is that the user can load more of these big data sets into an application at the same time. All objects can be in a reduced memory structure (compact or on disk) and only those on which some modifications need to be done need to be upgraded to some higher level. Only the strictly required information need be kept at all times. Extra required information can be constructed whenever needed.
3. A consequence of advantage 2 is that memory-to-disk-swapping will be reduced considerably, because less RAM is needed. Swapping can be done much more efficiently using the on-disk memory structure.
4. Faster loading of objects: the state of the art-programs that can do advanced manipulations on polygonal, e.g. triangle data load the objects into the extended data-structure and will thus consume more memory than strictly required. Furthermore it will require more time to get the data into memory. Loading into a lower level data-structure will allow the user to have the data in memory much faster, e.g. for view-only purposes.
5. Another advantage of the conversions (especially to a non-volatile memory state, e.g. an on-disk state, and back), is that memory fragmentation can be reduced. E.g. in the example of polygonal, e.g. triangles meshes, by doing some complex operations on the polygonal, e.g. triangle mesh objects, RAM memory may get highly fragmented. This means that representations of polygonals, e.g. triangles in memory, which are supposed to be right after each other, may be located at completely different places in memory. This may result in a performance loss in the subsequent operations. Even visualizing such fragmented objects may suffer from the fragmentation because the memory is accessed in a very random way. By the conversions, memory will be filled again in a logical way, meaning that polygonals, e.g. triangles following each other, will also be close to each other in memory, resulting in more efficient access of the data for the subsequent operations.

### PREFERRED EMBODIMENT

As indicated above, although the present invention can be extended to more different structures, as a preferred embodiment a scheme of 3 different memory structures is proposed.

These three memory structures are:

A “compact” data structure that holds all the necessary data, e.g. in RAM, to show an object to the user, e.g. in 3D representation of a first resolution. Only simple viewing operations are possible, e.g. no modifications which involve changes in the polygonal structure. This data structure can be of the type shown in FIG. 4.

A “rich” data structure that reserves RAM for much more extra information such as connectivity data. This extra information can allow the programmer to write algorithms in a much more efficient way, e.g. when extra calculations are required because the polygonal structure is changed or when advanced operations are required such as advanced editing. The resolution remains as for the compact data structure. The data structure can be a linked list as shown in FIG. 5.

An “on disk” data structure that allows swapping of the data of the object to be viewed from RAM to disk in a efficient and controlled way. The object will still be in the database of the application and will be easily retrievable again. In this state the data objects will require virtually no RAM memory.

In a typical use, the software will load the data initially into the “Compact” data structure, which consumes less memory, and is much faster to load, because no calculations for the extra references need to be made. Once a more complicated operation is performed, the software will automatically switch to a “rich” data structure, and it will keep the data in this rich data structure. When certain data are not used frequently during working with the software the program and/or the user can decide to put these data in the ‘On Disk’ structure, which consumes much less memory and is much more optimized than the normal Disk Swapping of the Operating System. The Operating System will swap data and or programs to disk which are not used for a while. This ‘on disk’ method is preferred because the OS does not know which data will be used or not, e.g. within the immediate future.

In a further embodiment the user is given the possibility to control and change the memory mode for each object separately.

What is claimed is:

1. A computer system comprising:
a memory system,
a display device,
a first data structure being a first 3D surface representation of a model and residing in the memory system and occupying a first amount of memory space and a means for converting the first data structure into a second data structure residing in the memory system and occupying a second amount of memory space being a second 3D surface representation of the model.

2. The computer system of claim 1, wherein the first and second 3D surface representations of the model represent the model with the same image resolution.

3. The computer system of claim 1, wherein either the first or second data structure are polygonal mesh representations of the surface of the 3D model.

4. The computer system of claim 1, wherein either the first or second data structure are polygonal mesh representations of the surface of the 3D model including connectivity data.

5. The computer system according to claim 1, wherein the first or second data structure are displayed on the display device as a wire frame or as a rendered image.

6. The computer system of claim 1, wherein at least a third data structure is provided, the third data structure being a 3D surface representation of the model.

7. The computer system of claim 6, wherein the third data structure represents the model with the same image resolution as the first and second data structure.

8. The computer system according to claim 6, wherein the first to third data structures are a first minimal data structure in the memory system having only that information needed to display a form of the 3D model, and a second rich data structure in the memory system having information required to perform operations on the model, or the third data structure.

9. The computer structure of claim 8, wherein except for some cached data, the third data structure is stored in a non-volatile memory.

10. The computer system according to claim 8, further comprising means to swap any of the first to third data structures with any other of the first to third structures in the non-volatile memory.

11. A computer system comprising:
a memory system,
a display device,
a processor, one computer program running on the processor,
wherein the one computer program is adapted to load data of a 3D model into the memory system and to represent this data into a structure which varies according to the conditions.

12. The computer system according to claim 11, wherein the first data structure is stored in random access memory as a simple array.

13. The computer system according to claim 11, wherein the second data structure is stored in random access memory as a linked list.

14. The computer system according to claim 11, wherein the first data structure is quicker to store in random access memory than the second data structure.

15. The computer system according to claim 11, wherein the first data structure is slower to manipulate for additions and deletions than the second data structure.

16. The computer system according to claim 11, wherein the computer program is adapted to load one of the first or second data structures based on:
1. a user graphics operation,
2. automatically at certain times or after certain operations, or
3. based on a user entered request.

17. A data structure as recited in claim 16 residing in a memory.

18. A computer program having code segments which implement the computer system of claim 11 when executed on a computer system.

19. A computer program that is adapted to load data describing 3D models into a memory system of a computing device and to represent this data in a data structure which varies according to the conditions.

20. A computer program according to claim 19, allowing 3 possible data structures: a compact data structure, a rich data structure or an ‘on-disk’ data structure.

21. A computer program according to claim 19 that is adapted to represent its data in one of the possible data structures based on
1. the knowledge that a requested operation is more efficient in another data structure.
2. expected future operations.
3. a user operation or
4. automatically at certain times or after certain operations.

22. A computer program according to claim 19 that has implemented some of its algorithms for multiple data structures.

23. A computer program according to claim 19 that is adapted to intelligently predict which operations are most likely to come, and to represent its data in the most suitable data structure for those operations.

24. A computer program according to claim 19 that will guide the user to perform its desired operations in a certain way, in order to minimize switching between different data structures.

25. A computer program according to claim 19 that first loads its data in a compact data structure, and then converts the data to a rich data structure as soon as a complex operation is requested by the user which is more optimal performed in this rich data structure.

26. A method of operating a computer system having a memory system, a display device, a processor, one computer program running on the processor, the method comprising the step of loading data of a 3D model into the memory system and representing this data into a structure which varies according to the conditions.
